(19) United States
(12) Patent Application Publication
(10) Pub. No.: US 2026/0187126 A1
(43) Pub. Date: Jul. 2, 2026

(54) METHODS AND SYSTEMS FOR DYNAMIC CONTEXT AND RESPONSE GENERATION OF VIRTUAL ASSISTANT SYSTEM

(71) Applicant: SAMSUNG ELECTRONICS CO., CO.,LTD., Suwon-si (KR)

(72) Inventors: Arun KUMAR, Noida (IN); Ankush TARIKA, Noida (IN); Anubhav SACHAN, Noida (IN); Harvind SINGH, Noida (IN)

(73) Assignee: SAMSUNG ELECTRONICS CO., CO.,LTD., Suwon-si (KR)

(21) Appl. No.: 19/546,034

(22) Filed: Feb. 20, 2026

Related U.S. Application Data
(63) Continuation of application No. PCT/KR2024/005802, filed on Apr. 29, 2024.

(30) Foreign Application Priority Data
Aug. 23, 2023 (IN) 202311056614

(51) Int. Cl. G06F 16/334; G06F 16/3329

(52) U.S. Cl. CPC G06F 16/3347; G06F 16/3329

(57) ABSTRACT

A method for generating a context in a virtual assistance (VA) system may include receiving raw data at each time step from a plurality of electronic devices connected with the VA system, extracting using a neural network (NN) model, a plurality of features corresponding to the plurality of electronic devices to generate a unified feature vector of the extracted plurality of features at the each time step, determining, using the NN model, an intermediate aligned feature at the each time step, determining, based on the unified feature vector and the intermediate aligned feature, a context and a priority of the context at the each time step, using the NN model, and storing the context and the priority of the context in a context database.

### CROSS-REFERENCE TO RELATED APPLICATION

This application is a bypass continuation application of International Patent Application No. PCT/KR2024/005802, filed on Apr. 29, 2024, which claims priority to Indian Patent Application number 202311056614, filed on Aug. 23, 2023, in the Indian Patent Office, the disclosures of which are incorporated herein by reference in their entireties.

### BACKGROUND

### 1. Field

The present disclosure generally relates to a virtual assistant system. In particular, the present disclosure relates to methods and systems for dynamic context management and response generation of the virtual assistant systems.

### 2. Description of Related Art

In recent years, Virtual Assistant (VA) systems such as chatbots have witnessed a surge in popularity owing to their diverse range of services and tasks. Specifically, chatbots are utilized for various purposes, including providing customer support, collecting information related to customers, products and related services, and the like. Generally, the VA systems are accessible through online platforms, websites, mobile apps, etc. VA systems engage with users, offering relevant information seamlessly and without the need for human intervention.

In a common scenario, VA systems used for customer services utilize and process the information given by the user. For instance, when a user requires some assistance with a product issue (e.g., a malfunctioning washing machine) or seeks information related to a service (e.g., opening a bank account), the user may opt to call customer service. At this point, the chatbot (the VA system) may take charge and attend to the user to resolve the user's issues and/or queries. Traditionally, the chatbot follows a standard methodology of asking the user specific questions. Based on the response provided by the user, the chatbot then directs the user to a relevant section to access the necessary information or proceed further with their query.

However, conventional methodologies implemented in chatbots and VA systems are largely linear, meaning they follow a predetermined sequence of questions and response paths. Further, the chatbots fails to consider a context of the user query, i.e., neglecting essential factors such as the user's current situation, events leading to the user query, or the relative urgency or priority of the request. For instance, a user's query might be influenced by the type of condition they are experiencing, the circumstances prompting their call to customer service, or their immediate needs and preferences. As a result of such limitation, traditional chatbots tend to provide responses based solely on the user's immediate input, without adapting to the broader context or intent behind the query.

Therefore, there may be a need for improved systems and methods that address the above-mentioned problems associated with conventional chatbots/VA systems.

### SUMMARY

In one or more embodiments of the present disclosure, a method for generating a context in a virtual assistance (VA) system, may include: receiving raw data at each time step from a plurality of electronic devices connected with the VA system; extracting using a neural network (NN) model, a plurality of features corresponding to the plurality of electronic devices to generate a unified feature vector of the extracted plurality of features at the each time step; determining, using the NN model, an intermediate aligned feature at the each time step; determining, based on the unified feature vector and the intermediate aligned feature, a context and a priority of the context at the each time step, using the NN model; and storing the context and the priority of the context in a context database.

In one or more embodiments of the present disclosure, a method for generating a dynamic response in a virtual assistance system, may include: receiving a user input; determining an intermediate entity feature and a sentence feature embedded in the user input by using a neural network (NN) model; fetching a relevant context corresponding to the intermediate entity feature from a context database based on a similarity between the intermediate entity feature and a stored context for each feature; determining a context aware entity feature by concatenating the fetched relevant context and the sentence entity feature based on the intermediate entity feature having the similarity to the stored context that exceeds a threshold value; and generating a dynamic response for a user based on the context aware entity feature.

In one or more embodiments of the present disclosure, a virtual assistance (VA) system for generating a context, may include: memory storing one or more instructions; and one or more processors configured to execute the one or more instructions to: receive raw data at each time step from a plurality of electronic devices connected with the VA device; and extract, using a first neural network (NN) model, a plurality of features corresponding to the plurality of electronic devices to generate a unified feature vector of the extracted plurality of features at the each time step; determine, using a second NN model, an intermediate aligned feature at the each time step; determine based on in the unified feature vector and the intermediate aligned feature, a context and a priority of the context at the each time step using the second NN model; and store the context and the priority of the context for each feature in the unified feature vector in a context database.

In one or more embodiments of the present disclosure, a virtual assistant (VA) system for generating a dynamic response in a virtual assistance system, may include: memory storing one or more instructions; and one or more processors configured to execute the one or more instructions to: receive a user input; determine an intermediate entity feature and a sentence feature embedded in the user input by using a neural network (NN) model; fetch a relevant context corresponding to the intermediate entity feature from a context database based on a similarity between the intermediate entity feature and a stored context for each feature; determine a context aware entity feature by concatenating the fetched relevant context and the sentence entity feature based on the intermediate entity feature having the similarity to the stored context that exceeds a threshold value; and generate a dynamic response for a user based on the context aware entity feature.

### BRIEF DESCRIPTION OF DRAWINGS

The above and/or other aspects will be more apparent by describing certain example embodiments, with reference to the accompanying drawings, in which:

FIG. 1 illustrates a general system architecture of the Virtual Assistant (VA) system according to one or more embodiments of the present disclosure;

FIG. 2 illustrates various components of the module/unit of the VA system of FIG. 1, according to an embodiment of the present disclosure;

FIG. 3 illustrates an operational flow of a method of the VA system, according to an embodiment of the present disclosure;

FIG. 4 illustrates a flow chart depicting a context generation process, according to an embodiment of the present disclosure;

FIG. 5 illustrates a flow chart depicting a response generation process, according to an embodiment of the present disclosure;

FIG. 6 illustrates a feature extraction operation performed by a feature extraction module, according to an embodiment of the present disclosure;

FIG. 7 illustrates an operation flow of the context generation module of FIG. 2, according to an embodiment of the present disclosure;

FIG. 8 illustrates an operation flow of the CANLU module of FIG. 2, according to an embodiment of the present disclosure. FIG. 8 depicts the operation flow 800 of the CANLU module; and

FIG. 9 illustrates an example scenario where the user is in conversation with the VA system to solve a device related issue, according to an embodiment of the present disclosure.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

In the present disclosure, a neural network (NN) model may include one or more neural networks, such as a feature extraction NN, a transformer-based language NN, or a context-aware language NN, without being limited thereto.

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

According to an embodiment, the present disclosure discloses a method and a system for determining a context of a user for generating a dynamic response in accordance with the context by a virtual assistance (VA) system. According to an embodiment, data from a plurality of information sources are collected and processed to determine the context. Based on the determined context, the VA system generates the dynamic response. This enables the user to have a meaningful interaction with the VA system.

According to another embodiment, the present disclosure discloses a method and a system for generating a dynamic response in the VA system. In an embodiment, an intermediate entity feature and a sentence feature embedded in a user input is determined using a NN module. Further, a relevant context corresponding to the obtained intermediate entity feature is fetched from a context database based on a similarity of the fetched relevant context with a stored context for each feature. Moreover, a context-aware entity feature is determined by concatenating the fetched relevant context and the sentence entity feature based on the fetched relevant context being similar to the stored context. Thereafter, a dynamic response is generated for a user based on the context-aware entity feature. Thus, the present disclosure takes into account the context of the user to share a dynamic response to the response which is relevant to the user. Thus, the present disclosure improves accessibility and reliability of the VA system.

A detailed methodology is explained in the following paragraphs of the disclosure.

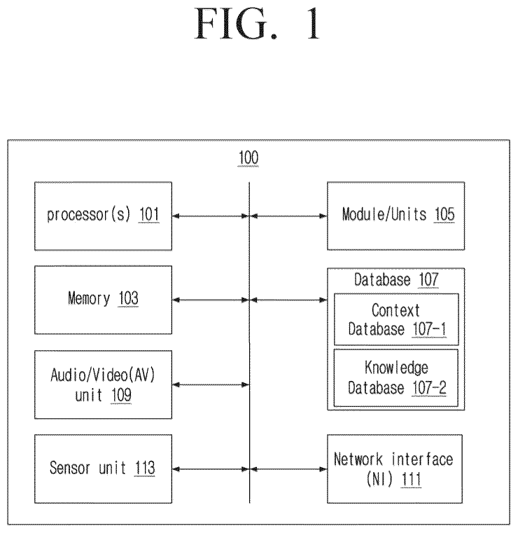

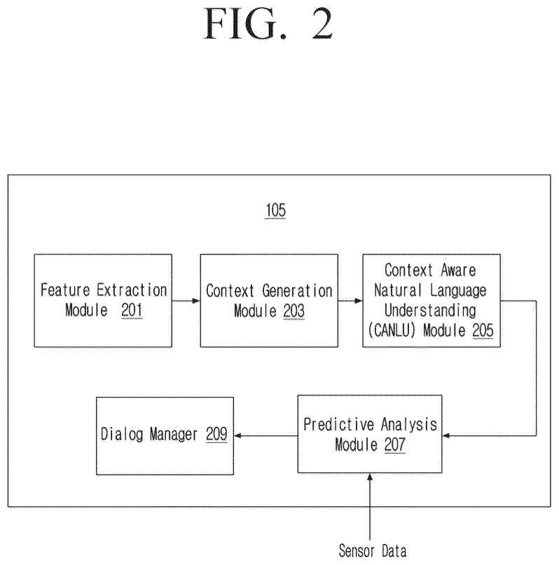

FIG. 1 illustrates an exemplary system architecture of a VA system 100 according to an embodiment of the present disclosure. The VA system 100 is configured to recognize user-related context, and generate corresponding contextual information and a corresponding dynamic response for the user. The VA system 100 includes a processor(s) 101, a memory 103, a module/unit 105, a database 107, Audio/Video (AV) unit 109, a Network Interface (NI) 111, a sensor unit 113 coupled with each other. FIG. 2 illustrates various modules that are part of the module/unit 105 of the VA system 100 of FIG. 1, according to an embodiment of the present disclosure. Particularly, the module/unit 105 as shown in FIG. 2 may include a feature extraction module 201, a context generation module 203, a Context Aware Natural Language Understanding (CANLU) module 205, a predictive analysis module 207, and a dialog manager 209 operate in collaboration with each other. The module/unit 105 may be implemented using the processor(s) 101 configured to execute one or more instructions stored in memory 103 and to retrieve data from memory 103. For example, if sensor data from the sensor unit 113 and data from the database 107 are stored in memory 103, the processor(s) 101 may access these data while executing the instructions to carry out the operations of module/unit 105.

Referring back to FIG. 1, as an example, the VA system 100 may correspond to various devices such as a Personal Computer (PC), a tablet, a Personal Digital Assistant (PDA), a mobile device, a palmtop computer, a laptop computer, a desktop computer, a communications device, dashboard, navigation device, a computing device, or any other machine capable of executing a set of instructions. According to an exemplary embodiment, the VA system 100 may be further connected with the information sources. As an example, information sources may correspond to one or more electronic devices (e.g., user terminals or servers) or Internet of Things (IoT) devices such as a smart washing machine, a smart microwave, a smart television, a smart refrigerator and the like. As a further example, the information sources may correspond to sensors, apps running on electronic devices, websites hosted on electronic devices and the like.

In an example, the processor 101 may be a single processing unit or a number of processing units, all of which could include multiple computing units. The processor 101 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 101 is configured to fetch and execute computer-readable instructions and data stored in the memory 103.

The memory 103 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s)/unit(s) 105 may include a program, a subroutine, a portion of a program, a software component, or a hardware component capable of performing a stated task or function. As used herein, the module(s)/unit(s) 105 may be implemented on a hardware component such as a server independently of other modules, or a module can exist with other modules on the same server, or within the same program. The module(s)/unit(s) 105 may be implemented on a hardware component such as processor one or more microprocessors, microcomputers, microcontrollers, digital signal processors, central processing units, state machines, logic circuitries, and/or any devices that manipulate signals based on operational instructions. The module(s)/unit(s) 105 when executed by the processor(s) 101 may be configured to perform any of the described functionalities.

As a further example, the database 107 may be implemented with integrated hardware and software. The hardware may include a hardware disk controller with programmable search capabilities or a software system running on general-purpose hardware. The examples of the database 107 are, but are not limited to, in-memory databases, cloud databases, distributed databases, embedded databases, and the like. The database 107, amongst other things, serves as a repository for storing data processed, received, and generated by one or more of the processors, and the modules/engines/units. According to an embodiment of the present disclosure, the database 107 includes a context database 107-1 and a knowledge database 107-2. As an example, the context database 107-1 stores contextual information related to users. Further, the knowledge database 107-2 includes various entities such as product data, user data, market data, third-party services, etc. The product data (also referred to as device data) contains data related to the products such as product specifications, working flow, user manuals, error codes, nodes, etc. The product's information may be required to obtain device-specific information. The user data contains user-specific information such as user profiles, customized filters, usage history, list of products used by the user, user preference, etc. The market data provides knowledge from external sources, such as public forums, blogs, support communities, etc. The market data may include documentation of known issues, troubleshooting steps, and common solutions. The market data further includes field issue reports acknowledged by the manufacturer along with associated workarounds or recommended resolutions. The third-party services have various APIs to obtain public/private information from numerous sources.

In an embodiment, the modules/units 105 may be implemented using one or more AI modules that may include a plurality of neural network layers. Examples of neural networks include but are not limited to, Convolutional Neural Network (CNN), Deep Neural Network (DNN), Recurrent Neural Network (RNN), Restricted Boltzmann Machine (RBM). The ‘learning’ may be referred in the disclosure is a method for training a predetermined target device (for example, a robot) using a plurality of learning data to cause, allow, or control the target device to make a determination or prediction. Examples of learning techniques include but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

As an example, the AV unit 109 receives audio data and video data from the one or more information sources that are connected with the VA system 100, or from sensors (e.g., microphones and cameras) that are integrated into or interact with the VA system 100. As a further example, the NI unit 111 establishes a network connection with a network like a home network, a public network, or a private network and the like. Further, the sensor unit 113 may include various sensors like temperature sensors, proximity sensors, pressure sensors, water quality sensors, chemical/gas sensors, infrared sensors, smoke sensors, motion sensors, level sensors, image sensors, humidity sensors, an accelerometer sensors, gyroscope sensors, an optical sensors, etc. The sensor unit 113 provides sensor data obtained from the various sensors for obtaining the contextual information related to the user. The contextual information related to the user may be also referred to as ‘context’ throughout the disclosure.

Referring back to FIG. 2, the feature extraction module 201 extracts raw data at each time step from the plurality of information sources that are connected with the VA system 100. As an example, the raw data may refer to unprocessed data as received from various information sources or as captured by sensors, prior to any significant transformation, filtering, or interpretation). In a non-limiting example, the raw data may include image data, audio data, sensor data, text data, and the like.

According to an embodiment, the context generation module 203 uses the raw data received from the various information sources and a previous context (i.e. the context generated at the previous time step) as inputs to generate a feature vector at each time step using the feature extraction module 201. The previous context is stored in and is accessible from the memory 103. The feature vector includes information extracted from the raw data. Further, after processing, the feature vector becomes a unified vector representation of the received raw data. The unified vector representation may be a consolidated and structured embedding that combines multiple modalities or types of raw input (e.g., audio, video, sensor data) into a single, coherent vector format suitable for downstream processing. Accordingly, the context generation module 203 further processes the unified vector representation of the received raw data using a neural network (NN) module to generate a context and a priority of the context at each time step. The generated context and the priority of the context are then stored in the database 107.

According to a further embodiment, the context aware natural language understanding (CANLU) module 205 receives user input during an initialization or launch of an application corresponding to the VA system 100 and/or receiving an initialization request via a suitable user input. The CANLU module 205 analyzes the user input to provide an entity that the user is addressing in the user input and a sentence feature. The CANLU module 205 extracts intermediate entity features, such as entity type or role, from the user input, and may identify attributes which are used to retrieve relevant context from the database 107.

According to an embodiment, the predictive analysis module 207 analyses the sensor data to understand and predict future faults in the user device/sensors that may be temporary and/or permanent in nature.

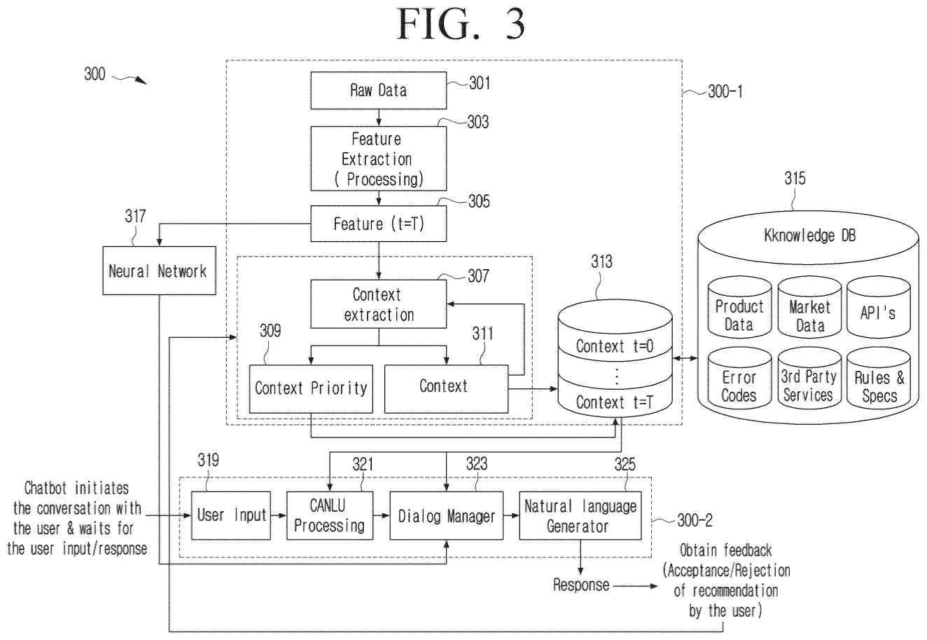

According to a further embodiment, the dialog manager 209 generates a customized dynamic response for the user based on a result of the analysis of the predictive analysis module 207, and the relevant context provided by the CANLU module 205. The dialog manager 209 initiates the conversation with the user. The user assists the dialog manager 209 by providing suitable responses, to enable the VA system 100 to obtain information corresponding to faulty devices in advance. A detailed working of each of the components of FIG. 2 will be explained in the forthcoming paragraphs through FIGS. 3 to 6.

FIG. 3 illustrates an operational flow corresponding to a method 300 of the VA system 100, according to an embodiment of the present disclosure. According to an embodiment, the present disclosure improves a dialog flow between the user and VA system 100 instilling the context in the conversation. The method 300 primarily involves two processes, i.e., a context generation process 300-1 and a response generation process 300-2, operating parallelly. The context generation process 300-1 generates context continuously at each time step and the response generation process 300-2 responds to incoming user queries based on the generated context(s). Since the context generation is a continuous process, the process may provide irrelevant information at some of the time steps. The process 300 effectively identifies said irrelevant information and prevents the VA system 100 from utilizing said information to generate the response(s). This reduces information overhead and enable implementation of both the processes in parallel to efficiently respond to the user.

According to an embodiment, the VA system 100 may include a neural network (317), a neural network (317) may receive the unified feature vector (305) together with the prior context (313) and computes a gating score to determine contextual relevance. Based on this score, neural network (317) filters out low-priority or irrelevant features before forwarding the surviving features to the context extraction operation (307). By excluding such irrelevant information, neural network (317) reduces noise in the downstream context generation process.

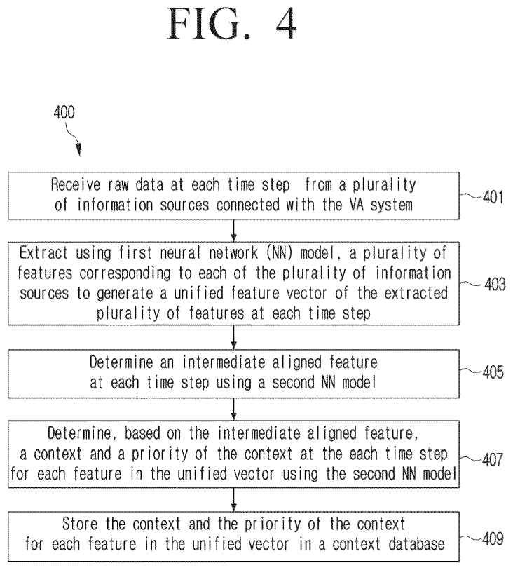

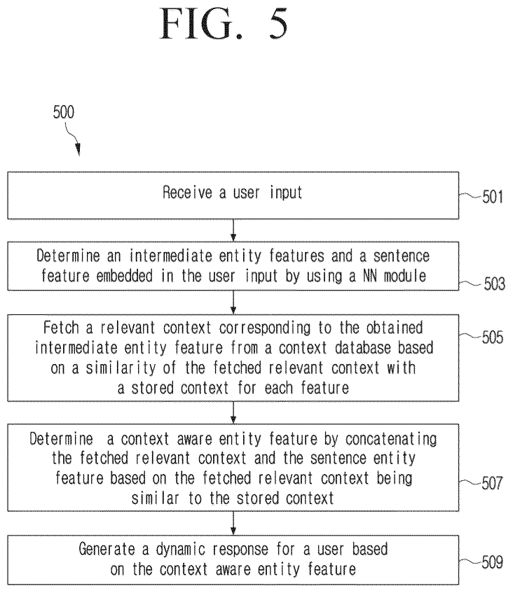

FIG. 4 illustrates a flow chart depicting the context generation process 300-1, according to an embodiment of the present disclosure. The context generation process 300-1 may be also referred to as a method 400 throughout the disclosure without deviating from the scope of the disclosure. Further, FIG. 5 illustrates a flow chart depicting the response generation process 300-2, according to an embodiment of the present disclosure. The response generation process 300-2 may be also referred to as a method 500 throughout the disclosure without deviating from the scope of the disclosure. Operations 501 and 503 of FIG. 5 correspond to the reception of a user input and the preliminary feature extraction of the user input, respectively, as described above with reference to the CANLU module. The context generation process 300-1 and the response generation process 300-2 will be explained by referring to the overall operational flow of the method 300 for the sake of brevity.

According to an embodiment, the method 300 is implemented in the system 100 of FIG. 1. The method 300 may be performed by the various modules as shown in FIG. 2. The method 300 may be performed by the processor(s) 101 of FIG. 1. Further, the explanation of the method 300 will be provided through the operations of various modules as shown in FIG. 2.

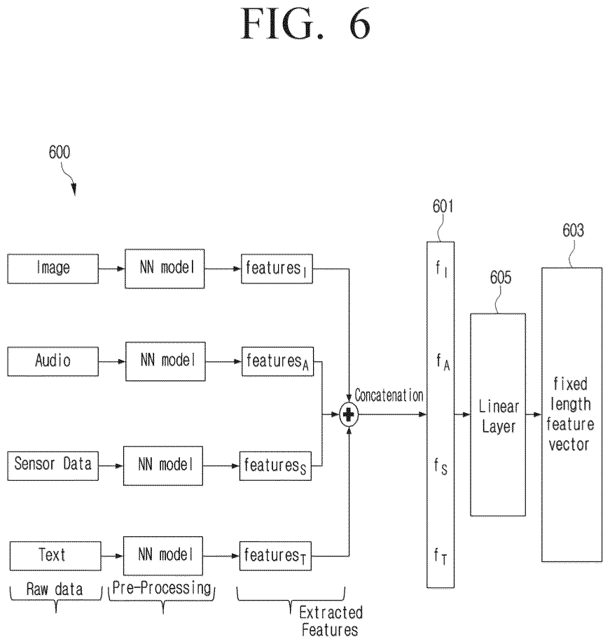

According to an embodiment, at operations 301, 303, and 305, the features extraction module 201 receives the raw data at each time step from the plurality of information sources that are connected with the VA system 100. The raw data is pre-processed at each time step to extract a plurality of features. FIG. 6 illustrates a feature extraction operation performed by the feature extraction module, according to an embodiment of the present disclosure. According to an embodiment, method 600 depicts the feature extraction process for various raw data. In a non-limiting example, image data, audio data, sensor data, and text data are considered here for example purposes as the raw data.

Returning to FIG. 3, at operation 301, the feature extraction module 201 receives the raw data. The feature extraction module 201 feeds the raw data to various NN models for extracting the respective features of the raw data. The feature extraction module 201 then processes the raw data corresponding to each of the plurality of information sources using the NN models to extract the plurality of features. The extraction of the features corresponds to operation 303. The raw data corresponding to each of the plurality of information sources is processed parallelly to each other. The feature extraction module 201 then concatenates the extracted plurality of features to obtain a feature vector 601. The concatenation may be static or adaptive in nature. Thereafter, the feature vector 601 representation is sent to a linear layer 605. In a non-limiting example, the linear layer 605 includes 2048 neurons with 256 learnable neurons that convert the feature vector 601 into a fixed-length representation. Accordingly, the feature extraction module 201 generates a unified feature vector of a fixed length i.e., a fixed-length feature vector 603 from the feature vector 601. As the extracted features are obtained from different information sources and are in a different format from each other, therefore in order to simplify the feature vector 601 for further processing, the fixed length feature vector which is unified in nature is obtained. The generation of the fixed-length feature vector 603 corresponds to operation 305. The feature extraction process for various raw data is explained in the following paragraphs.

According to an example embodiment, for extracting features from the image data, initially, the image is divided into (N×N) sized patches. Then each patch is sent to the NN model. In the present example embodiment, a pre-trained convolutional NN model like ResNet-18, VGG-16 may be used to extract features I. The features I are then further processed to produce a fixed-length feature (e.g. shape=(256, 1)) respective to N patches. These N patches are aligned in raster order to form a fixed-length feature vector of shape=(N×256, 1). The N and the pre-trained convolutional NN model are predefined during the implementation process.

According to a further example embodiment, for extracting features from the audio data, initially, the audio file is processed to generate a mel-spectrogram which is sent to a pre-trained convolution NN module to extract features A. The features Aare then further processed to produce fixed-length features for size (512×1). According to a yet further example embodiment, for extracting the features from the text data, the text is encoded via SentencePiece with M sub-words into an integer range [0, M). In a further example, for the NN mode to create word embedding, the M may be considered as 32000. These encoded tokens are sent to a neural network-based language model to create contextual embedding, referred to as features T. The neural network-based language model may be a transformer-based model, such as Bidirectional Encoder Representations from Transformers (BERT), or a word embedding model, such as Word2Vec. The features T are then further processed to produce a fixed-length feature vector. As a yet further example embodiment, for extracting features from the sensor data, the sensor data is discretized, if the data is continuous, into a fixed length sequence of integers in row-major format and subsequently normalized. The discrete data is then sent through a pre-trained encoder NN model to extract features S. The features S are then processed to create a fixed vector length representation of the sensor data.

Accordingly, the fixed length feature vector 603 is the unified representation of the features extracted from various information sources for the context generation, and the representation at a particular time step t=T is represented as h_{t=T}. The fixed length feature vector 603 is then sent to the context generation module 203 for further processing. The fixed length feature vector 603 is also utilized by the response generation process 300-2. Operations 301, 303, and 305 correspond to the operations at operations 401 and 403 of FIG. 4. The neural network-based language model described above may correspond to the first NN model in FIG. 4. Now, the operation of the context generation module 203, will be explained in the forthcoming paragraphs.

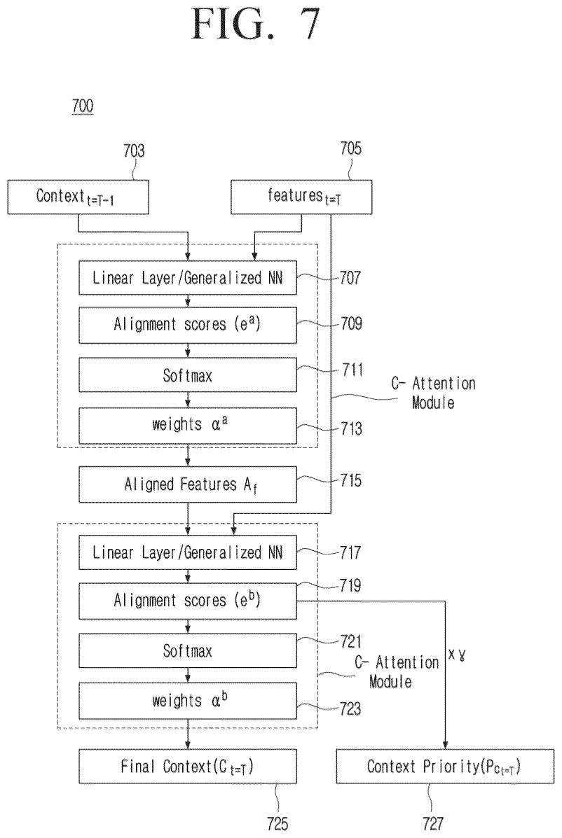

After extracting the features by the feature extraction module 201, method 300 proceeds to determine a context by the context generation module 203. FIG. 7 illustrates an operation flow of the context generation module of FIG. 2, according to an embodiment of the present disclosure. FIG. 7 depicts the operation flow 700 of the context generation module. The operation flow 700 of the context generation module will be explained by referring to FIG. 3. According to an embodiment, for operation 307, the context generation module 203 receives the fixed length feature vector 603 (maybe alternatively referred to as the unified feature vector) and the previous context i.e., the context at the previous time step. As an example, the previous context may be stored in the memory 103. Accordingly, the context generation module 203 receives the previous context from the memory 103. The features that are aligned with the fixed length feature vector 603 and a corresponding feature in the previous context are required to be determined for context determination. According to the present disclosure, the context at a particular time step Cter is enriched if another context from history is also considered while generating the context C_{t=T}. Hence, a recurrence relation such that a context at the time stamp may be considered based on equation 1:

$${C}_{t = T} = f ( {h}_{t = T} , {C}_{t = T - 1} ) \qquad ( 1 )$$

The functionality of function ƒ is given by a set of neural network architectures/models referred to as a Context Extraction Neural Network (CENN). The CENN model includes the C-Attention Module. The CENN model takes the input of h_{t=T} 703 (i.e., the fixed length feature vector 603) and C_{t=T-1} 705 (i.e., the previous context) to provide a context feature vector C_{t=T} along with its priority P_{c}_{_{t=T}}. The priority of the context is based on the alignment scores of h_{t=T} with the context C_{t=T} and ranges in [0, p] ∀ p ∈ [symbol] .

In an implementation, for operation 307, the context generation module 203 provides the unified feature vector and the previous context at the previous time step to the CENN model. That is to say, the CENN module takes the context C_{t=T-1} 703 (the previous context) and features h_{t=T} 705 as an input. The input is then sent to a uniquely designed C-Attention Module which is inspired by the Self-Attention Mechanism (SAM). In an embodiment, the SAM focused on extracting the alignment of the words in a sentence and subsequently predicting the next word in that sentence based on the learned probability distributions. According to the present disclosure, the SAM is modified to be used for non-language related tasks in obtaining a relevance between two or more vectors to finally obtain a final feature vector containing properties of the rest of the vectors.

According to an embodiment, the aforesaid input is received at a linear layer/Generalized NN 707. Further, after taking the aforesaid inputs, linear layer/Generalized neural network (NN) 707 of the context generation module 203 further calculates a first alignment score (e^{a}) 709 respective of each feature in the unified feature vector between each feature in the unified feature vector and a corresponding feature in the previous context at a previous time step by using the C-Attention Module of the CENN model.

The context C_{t=T-1} 703 and features h_{t=T} 705 are sent to a function g (h_{t=T}, C_{t=T}-1) to obtain a vector of the first alignment scores (e^{a}) 709 which is given by:

$${e}^{a} = g ( {h}_{t = T} , {C}_{t = T - 1} ) \qquad ( 2 )$$

The function g can be represented by any neural network. Further, the vector of the first alignment scores provides a general idea about the alignment/relevance between the inputs (i.e., h_{t=T} and C_{t=T-1}).

Thereafter, the context generation module 203 obtains through a softmax layer 711 a first weight vector α^{α}713 including weights assigned to each feature in the unified feature vector based on the first alignment score 709. That is, the e^{a} 709 is passed through the softmax layer 711 to obtain the first weights vector aa 713.

The context generation module 203 further obtains the intermediate aligned feature

$$( {A}_{f}^{a} )$$

715 based on the obtained the first weight vector 713. The intermediate alignment feature 715 may be obtained by following equation 3:

$${A}_{f}^{a} = {α}^{a} \cdot {h}_{t = T} \qquad ( 3 )$$

The operation for obtaining the intermediate alignment feature corresponds to operation 405 of FIG. 4. The second NN model at operation 405 may include, execute, or interact with the CENN model which includes the C-attention module.

According to an embodiment, the intermediate aligned feature 715 that is obtained acts as an input along with the features h_{t=T} 705 for another round of processing by the C-Attention Module. During the further round of processing a final context 725 and the priority 727 is determined. In an implementation, the context generation module 203 provides the intermediate aligned feature 715 and the unified feature vector 603/705 to the linear layer/generalized NN 717 of the C-Attention Module. The context generation module 203 then calculates a second alignment score (e^{b}) 719 respective of each feature in the unified feature vector 603/705 and a corresponding feature in the intermediate aligned feature 715 by using the C-Attention Module. Accordingly, the features h_{t=T} and the alignment features

$${A}_{f}^{a}$$

are sent to the previous function g such that then second alignment score (e^{b}) 719 may be obtained by equation (4).

$${e}^{b} = g ( {h}_{t = T} , {A}_{f}^{a} ) \qquad ( 4 )$$

After obtaining the second alignment score (e^{b}) 719, the context generation module 203 obtains a second weight vector that includes weights assigned to each feature in the intermediate aligned feature 715 based on the second alignment score (e^{b}) 719. Thus, the context generation module 203 obtains the context 311 based on the obtained the second weight vector. Further, the priority of the context is determined based on the second alignment score.

Accordingly, the e^{b} 719 is thus processed through the softmax layer 721 to obtain the final set of weights vector ab 723 which are further processed to get the final context 311/725 features that may be obtained by equation (5).

$${C}_{t = T} = {α}^{b} \cdot {h}_{t = T} \qquad ( 5 )$$

The operation of the context determination as explained above corresponds to operations at 307 and 407.

According to an embodiment, in order to determine the priority (P_{c}_{_{t=T}}) 727 of the context 311/725, the context generation module 203 provides the context respective of each feature in the second NN model. The context generation module 203 determines a category of an event associated with the context respective of each feature using the second NN model. In particular, the category is determined using a pre-trained classification neural network model. In a non-limiting example, consider that the classification neural network model comprises n=6 hidden layers with h₁ has 512 neurons, h₂ has 1024 neurons, h₃ has 2048 neurons, h₄ has 512 neurons, and h₅ has 256 neurons, and the final hidden layer h₆ is the softmax layer. Accordingly, the output classes obtained from the pre-trained classification neural network model offal into k categories related to, for example, financial fraud (e.g., amount debited, but order not placed), financial information (e.g., unified payments interface (UPI) services not available, hence only credit card is available), market data (e.g., widespread outage for a feature), device data (for example, error code from a SmartThings-connected device), etc. This category classification neural network is trained using backpropagation using cross-entropy loss.

Upon determining the category, the context determination module 203 calculates a dynamic score (μ) based on at least one of the determined categories, user feedback, market data, and recent trends associated with the context. This facilitates obtaining a dynamic priority list of each user bringing in a personalization factor. The dynamic score may be determined by the following equation (6)

$$μ = β s \qquad ( 6 )$$

where β is a constant s is based on a predefined severity factor table 1 for each category. The predefined severity factor is dynamic and is learned based on the activities of the user from various sources such as knowledge database 107-2, the web, etc. Since various events differ in priority, more urgent issues need to be handled first. For example, at a particular point of time, the user's watch is lost, and simultaneously a fraud transaction has happened using the user's credit card. Thus, the fraud transaction may be given a higher priority as compared to another event. To handle such cases, the dynamic score (μ) is determined based on the category of the occurred event, the recent trends related to that event, etc. This allows obtaining a dynamic priority list of each user bringing in the personalization factor.

Upon determining the dynamic score, the context generation module 203 calculates the severity factor associated with the context respective of each feature based on the dynamic score and the user feedback in response to a previous recommendation. The severity(s) is determined by a constant γ that factors in the severity(s) of the event. The mathematical function of the constant γ may be defined by the following equation (7):

$$γ = p ( μ ) + q ( f ) \qquad ( 7 )$$

TABLE 1

| Severity | Categories |
|---|---|
| 0 | Financial (Frauds, Loss of valuable items, etc.) |
| 1 | Products having widespread outage |
| . . . | . . . |
| N | Delivery of non-expensive items |

where p(x) and q(x) are functions approximated by the second NN model.

Accordingly, the context determination module 203 determines the priority (P_{c}_{_{t=T}}) 727 of the context 309 based on the second alignment score (e^{b}) and the constant γ that factors in the severity(s) of the event. Accordingly, the context priority 727/309 may be obtained by the following equation (8):

$${P}_{{c}_{t = T}} = γ \cdot max ( {\hat{e}}^{b} ) \qquad ( 8 )$$

where ê^{b} means e^{b} is normalized such that

$${\hat{e}}^{b} = \frac{{e}^{b}}{‖ {e}^{b} ‖} and γ .$$

The operation for determination of the priority of the context 309 as explained above corresponds to the operation at step 407 of FIG. 4.

According to an embodiment, the context generation module 203 further stores the context and the priority of the context for each feature in the unified vector in the context database 107-1. The context and its priority thus obtained are then utilized during the response generation process 300-2. The storing of the context and the priority of the context corresponds to operation 409 of FIG. 4. The forthcoming paragraphs disclose the process of context generation 300-2.

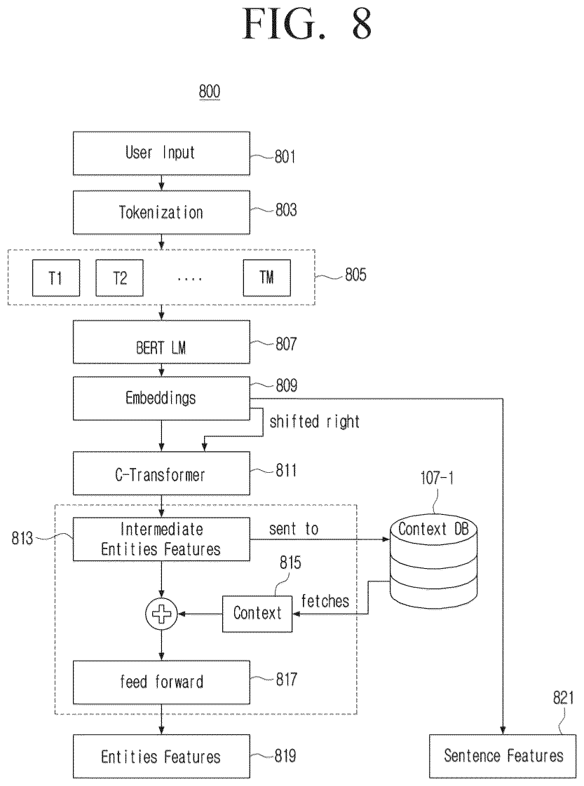

FIG. 8 illustrates an operation flow of the CANLU module of FIG. 2, according to an embodiment of the present disclosure. FIG. 8 depicts the operation flow 800 of the CANLU module. The operation flow 800 of the context generation module will be explained by referring to FIG. 3. According to an embodiment, at operation 319, the CANLU module 205 receives the user input 801. The user input 801 may be text input, voice input, query, and the like. The CANLU module 205 further obtains an intermediate entity feature and a sentence feature embedded in the user input by using the NN module.

In an implementation, the user input 801 (e.g., a sentence) is tokenized by performing tokenization at operation 803 using SentencePiece tokenizer to provide M tokens 805. The M tokens 805 may be provided by the following equation (9):

$$M = 6 {4}^{n} ∀ n ∈ ℕ \geq 4 tokens . \qquad ( 9 )$$

These M tokens 805 are then sent to a neural network-based language model (LM) 807, such as a Bidirectional Encoder Representations from Transformers Language Model (BERT LM), to provide embeddings 809 for the user input 801 such that key features of the sentence are captured. Accordingly, from the embeddings 809, the sentence features 821 are obtained.

Further, the embeddings 809 are further processed using a uniquely designed contextual transformer (C-Transformer) 811 such that it provides the intermediate entity features 813. According to an embodiment, the C-Transformer 811 takes the sentence embeddings as input and then shifts the sentence embedding ‘n’ places to the right and processed through the C-Transformer 811. The output from the C-Transformer 811 is normalized and split into two parallel streams. The two streams may be referred to as stream 1 and stream 2. The stream 1 is utilized to obtain features using a general feed-forward neural network, and then adding the input again to remove instances of catastrophic forgetting. The output from the stream 1 is then sent to the C-Transformer 811 of stream 2 and along with the output that is normalized from the C-Transformer 811. The output from the aforesaid operation is then added and normalized to send it to a feed-forward neural network to compute the intermediate entity features 813. The intermediate entity features 813 are then further utilized to fetch the relevant context from the context database 107-1.

After obtaining the intermediate feature 813, the CANLU module 205 fetches a relevant context 815 corresponding to the obtained intermediate entity feature 813 from the context database 107-1 based on a similarity between the intermediate entity feature 813 and the stored context in the context database 107-1. Accordingly, the intermediate entity feature 813 that is similar to any of the contexts stored in the context database 107-1 that context 815 is fetched as the relevant context from the context database 107-1.

According to an example embodiment, the intermediate entity features 813 generated by the C-Transformer 811 are used to fetch the most relevant context using the fetching algorithm by performing a similarity check (e.g., cosine similarity) between the intermediate entity and the context from context database 107-1. The similarity check obtains a similarity score s. The CANLU module 205 provides a similarity score based on a degree of matching of the similarity. Accordingly, the relevant context is fetched based on the following equation (10):

$$Relevant Context = \{ \begin{matrix}Matching Context , & if s \geq {s}_{t} \\ Context with highest priority , & otherwise\end{matrix} \qquad ( 10 )$$

Accordingly, if the similarity score is greater than a threshold score value (st) for the corresponding context that is stored in the context database 107-1, then that context will be fetched as the relevant context and utilizing the relevant context for further processing. Now, if the similarity score is less than the threshold score value (St) for the corresponding context that is stored in the context database 107-1, then that context among the similar context that has the highest priority will be fetched as the relevant context.

After fetching the relevant context from the context database 107-1, the CANLU module 205 obtains a context-aware entity feature by concatenating the fetched relevant context with the sentence feature 821. The relevant context (i.e., the context 815) and the intermediate entity features 813 are concatenated to encode through a feedforward neural network module 817 to provide the context-aware entity feature (i.e., entities feature 819) with a fixed-length feature vector.

The working of the CANLU module 205 as explained above corresponds to operation 321. Further, fetching the relevant context and determining the context-aware entity feature as explained above corresponds to operations 505 and 507 respectively. The context-aware entity feature is further used by the dialog manager 209 for dynamic response.

According to an embodiment of the present disclosure, the extracted plurality of features (i.e. the unified feature vector 603) from operation 305 is then provided to the predictive analysis module 207. The predictive analysis module 207 predicts a possible error in at least one of the IoT devices among the plurality of the IoT devices. In an implementation, the features (i.e. the unified feature vector 603) from the features extraction module 201 are representations of the sensor data from the user device, and its connected devices like washing machine, air conditioner, etc. are processed by the neural network predictive analysis stream. The predictive analysis module 207 predicts the possible error code that may occur in the future. The result of the predictive analysis is then sent to the dialog manager 209.

According to an embodiment, at operation 323 of the dialog manager 209, the dialog manager 209 verifies if the result of the predictive analysis is critical and contextually relevant by comparing it with the contexts that are already available in the context database 107-1. Based on the result of the comparison and the context-aware entity feature provided by the CANLU module 205, the dialog manager 209 takes an action. In a non-limiting example, the action includes providing a warning to the user in the form of an alert or initiating a ticket obtaining process with a customer support team and the like. Further, based on the action taken, a natural language generation (NLG) unit 325 provides the required information to the user. In a non-limiting example, the action can range from calling an API, gathering data, or providing a custom response to obtain more information from the user to satisfy its original query and the like.

The VA system can also provide solutions in the form of a sentence. In a non-limiting example, the sentence may be generated based on information that can be acquired from the database 107 which may further contain the information from an internet and proprietary data as well. The operation of the generation of the response by the dialog manager 209 corresponds to operation 509 of FIG. 5. The forthcoming paragraphs further provide various case studies implementing the methodology as disclosed above.

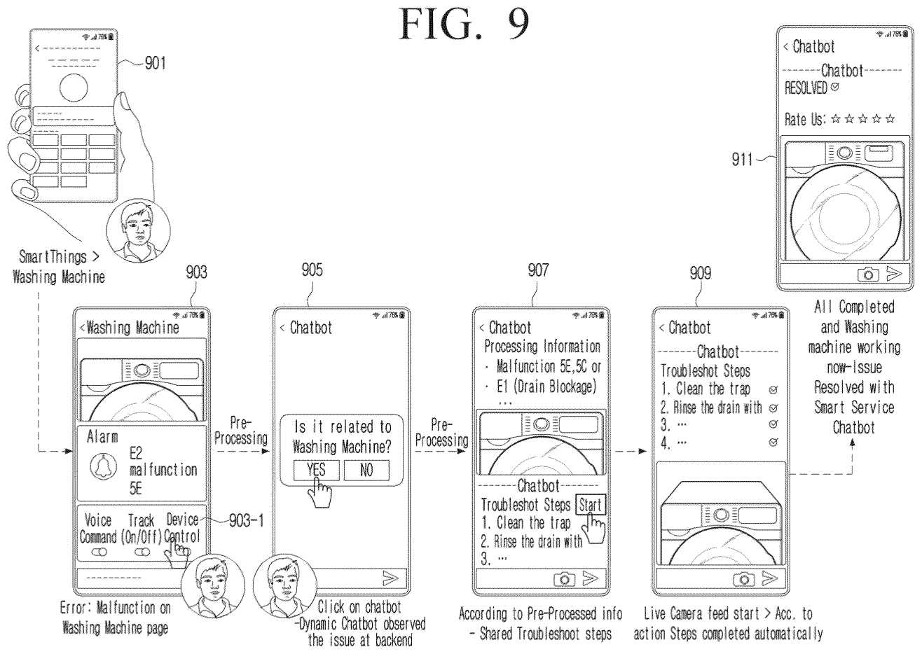

FIG. 9 illustrates an example scenario in which a user interacts with the VA system to solve a device-related issue, according to an embodiment of the present disclosure. In this example scenario, the user encounters a problem while operating a washing machine (e.g., an error E2 in the washing machine). Upon encountering this issue, the user may launch an application (App) at steps 901 and 903, which in turn triggers the method 300 as explained above. When the user opens the App, the method 300 may initiate a chatbot. The chatbot starts processing the information corresponding to the user in the background. On the user clicking the “device control” button at step 903-1, the chatbot 100 may display various queries to the user. For example, the chatbot 100 may ask the user whether the problem relates to a specific device (for example, the chatbot may display that “is it related to washing machine”) at step 905. Specifically, the chatbot 100 observes this issue at the backend. Thus, according to the pre-processed information, the chatbot 100 may share the troubleshoot steps as shown at steps 907 and 909. Further, the chatbot 100 may display completion of the task after successfully resolving the issue/query, at step 911. Further, the chatbot 100 may obtain user feedback at this stage i.e., after resolving the issue/query. According, to some example embodiments, the user feedback may be used during future processing.

According to a further example scenario, consider that the user is doing shopping and went to a counter for payment. Further, the user may prefer a cashless transaction, hence the user is using app-based payment system for payment, however, in an example scenario while initiating the payment, the app-based payment system may give error. In such a scenario, the user is unable to identify the issue. Further, the user is not having physical card. In such a case, the dynamic chatbot may recognize the problem and connects the user automatically to concern department related to issue with the payment app. The chatbot may guide some steps to use the app-based payment system for payment based on the identified issue. Thus, the chatbot resolves the issue quickly and saves the time by eliminating the need to call to IVR, explain issue, and/or connect with concern team.

According to a further example scenario, the VA system like an autonomous vehicle connected with a chatbot may be used in case of emergency or for support. For example, in a case consider that the user is on highway and witness an accident. As the location and sensors information already available in the autonomous vehicle, and with a server, the chatbot may sense the event based on the sensor data and starts processing the information based on location, and the sensor data (i.e., about car condition or so after accident). Accordingly, a smart watch/mobile immediately connect or pass the information to nearby hospital and their family members or friends.

In one or more embodiments of the present disclosure, a method for generating a context in a virtual assistance (VA) system, may include: receiving raw data at each time step from a plurality of electronic devices connected with the VA system; extracting using a neural network (NN) model, a plurality of features corresponding to the plurality of electronic devices to generate a unified feature vector of the extracted plurality of features at the each time step; determining, using the NN model, an intermediate aligned feature at the each time step; determining, based on the unified feature vector and the intermediate aligned feature, a context and a priority of the context at the each time step, using the NN model; and storing the context and the priority of the context in a context database.

The extracting of the plurality of features may include: feeding the raw data corresponding to each of the plurality of electronic devices into the NN model; processing the raw data corresponding to each of the plurality of electronic devices using the NN model to extract the plurality of features; concatenating the extracted plurality of features to obtain a feature vector; and generating the unified feature vector of a fixed length from the feature vector.

The determining of the intermediate aligned feature for the each time step using the NN model may include: providing the unified feature vector and a previous context at a previous time step to the NN model; calculating a first alignment score respective of each feature in the unified feature vector between each feature in the unified feature vector and a corresponding feature in the previous context at the previous time step by using the NN model; obtaining a first weight vector including weights assigned to each feature in the unified feature vector based on the first alignment score; and obtaining the intermediate aligned feature based on the obtained the first weight vector.

The determining of the context at the each time step for each feature in the unified vector may include: providing the intermediate aligned feature and the unified feature vector to the NN model; calculating a second alignment score respective of each feature in the unified feature vector and a corresponding feature in the intermediate aligned feature by using the NN model; obtaining a second weight vector including weights assigned to each feature in the intermediate aligned feature based on the second alignment score; and obtaining the context based on the obtained the second weight vector.

The priority of the context, respective of each feature, may be determined based on the second alignment score.

The method may further include: providing the context respective of each feature in the NN model; and determining a category of an event associated with the context respective of each feature using the NN model.

The method may further include: calculating a dynamic score based on at least the determined category, a user feedback, a market data and recent trends associated with the context; and calculating a severity factor associated with the context respective of each feature based on the dynamic score and the user feedback in response to a previous recommendation.

The receiving of the raw data may include receiving at least one of image data, audio data, sensor data, or text data, and the plurality of electronic devices may include at least one of a plurality of sensors, a plurality of user terminals, or a plurality of servers.

The method may further include: receiving a user input; obtaining an intermediate entity feature and a sentence feature embedded in the user input using the NN model; fetching based on a similarity between the intermediate entity feature and the stored context for each feature, a relevant context corresponding to the obtained intermediate entity feature from the context database; and obtaining a context aware entity feature by concatenating the fetched relevant context with the sentence feature based on the intermediate entity feature having the similarity to the stored context that exceeds a threshold value.

The method may further include: generating a dynamic response for a user based on the context aware entity feature.

The method may further include: predicting an error in at least one electronic device among the plurality of electronic devices based on the extracted plurality of features corresponding to each of the plurality of electronic devices.

The method may further include: comparing the predicted error with the stored context in the context database; and generating one or more actions based on a result of the comparison, wherein the one or more actions may include at least one of notifying a user with a warning, calling a relevant application, initiating a relevant action, or providing a response to the user with relevant recommendation.

In one or more embodiments of the present disclosure, a method for generating a dynamic response in a virtual assistance system, may include: receiving a user input; determining an intermediate entity feature and a sentence feature embedded in the user input by using a neural network (NN) model; fetching a relevant context corresponding to the intermediate entity feature from a context database based on a similarity between the intermediate entity feature and a stored context for each feature; determining a context aware entity feature by concatenating the fetched relevant context and the sentence entity feature based on the intermediate entity feature having the similarity to the stored context that exceeds a threshold value; and generating a dynamic response for a user based on the context aware entity feature.

In one or more embodiments of the present disclosure, a virtual assistance (VA) system for generating a context, may include: memory storing one or more instructions; and one or more processors configured to execute the one or more instructions to: receive raw data at each time step from a plurality of electronic devices connected with the VA device; and extract, using a first neural network (NN) model, a plurality of features corresponding to the plurality of electronic devices to generate a unified feature vector of the extracted plurality of features at the each time step; determine, using a second NN model, an intermediate aligned feature at the each time step; determine based on in the unified feature vector and the intermediate aligned feature, a context and a priority of the context at the each time step using the second NN model; and store the context and the priority of the context for each feature in the unified feature vector in a context database.

In one or more embodiments of the present disclosure, a virtual assistant (VA) system for generating a dynamic response in a virtual assistance system, may include: memory storing one or more instructions; and one or more processors configured to execute the one or more instructions to: receive a user input; determine an intermediate entity feature and a sentence feature embedded in the user input by using a neural network (NN) model; fetch a relevant context corresponding to the intermediate entity feature from a context database based on a similarity between the intermediate entity feature and a stored context for each feature; determine a context aware entity feature by concatenating the fetched relevant context and the sentence entity feature based on the intermediate entity feature having the similarity to the stored context that exceeds a threshold value; and generate a dynamic response for a user based on the context aware entity feature.

Accordingly, the present disclosed methodology provides a dynamic response based on the contextual information related to the user. The method implanted in the VA system easily resolves the customer query based on pre-trained data and the context obtained. Thus, according to the present methodology, the relevant response is being provided to the user. As the present methodology discloses a method of extracting context from unified representation of individual features where features and previous context are combined in a two-step process to calculate the final context and its priority. This extracted context is then incorporated into the user input to obtain better entity features which subsequently leads to context-aware decision making for dialog manager units. As explained above, the disclosed method provides a solution to incorporate context from multiple sources and continuous feedback to the user input, this provides an improved system as compared to the conventional system. The data from these multiple sources is continuously analyzed and intimates the user in case of any future abnormality in the functioning of a device or any future event.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for generating a context in a virtual assistance (VA) system, the method comprising:
receiving raw data at each time step from a plurality of electronic devices connected with the VA system;
extracting using a neural network (NN) model, a plurality of features corresponding to the plurality of electronic devices to generate a unified feature vector of the extracted plurality of features at the each time step;
determining, using the NN model, an intermediate aligned feature at the each time step;
determining, based on the unified feature vector and the intermediate aligned feature, a context and a priority of the context at the each time step, using the NN model; and
storing the context and the priority of the context in a context database.

2. The method as claimed in claim 1, wherein the extracting of the plurality of features comprises:
feeding the raw data corresponding to each of the plurality of electronic devices into the NN model;
processing the raw data corresponding to each of the plurality of electronic devices using the NN model to extract the plurality of features;
concatenating the extracted plurality of features to obtain a feature vector; and
generating the unified feature vector of a fixed length from the feature vector.

3. The method as claimed in claim 1, wherein the determining of the intermediate aligned feature for the each time step using the NN model comprises:
providing the unified feature vector and a previous context at a previous time step to the NN model;
calculating a first alignment score respective of each feature in the unified feature vector between each feature in the unified feature vector and a corresponding feature in the previous context at the previous time step by using the NN model;
obtaining a first weight vector comprising weights assigned to each feature in the unified feature vector based on the first alignment score; and
obtaining the intermediate aligned feature based on the obtained the first weight vector.

4. The method as claimed in claim 1, wherein the determining of the context at the each time step for each feature in the unified vector comprising:
providing the intermediate aligned feature and the unified feature vector to the NN model;
calculating a second alignment score respective of each feature in the unified feature vector and a corresponding feature in the intermediate aligned feature by using the NN model;
obtaining a second weight vector comprising weights assigned to each feature in the intermediate aligned feature based on the second alignment score; and
obtaining the context based on the obtained the second weight vector.

5. The method as claimed in claim 4, wherein the priority of the context, respective of each feature, is determined based on the second alignment score.

6. The method as claimed in claim 1, further comprising:
providing the context respective of each feature in the NN model; and
determining a category of an event associated with the context respective of each feature using the NN model.

7. The method as claimed in claim 6, further comprising:
calculating a dynamic score based on at least the determined category, a user feedback, a market data and recent trends associated with the context; and
calculating a severity factor associated with the context respective of each feature based on the dynamic score and the user feedback in response to a previous recommendation.

8. The method as claimed in claim 1, wherein the receiving of the raw data comprises receiving at least one of image data, audio data, sensor data, or text data, and wherein the plurality of electronic devices comprises at least one of a plurality of sensors, a plurality of user terminals, or a plurality of servers.

9. The method as claimed in claim 1, further comprising:
receiving a user input;
obtaining an intermediate entity feature and a sentence feature embedded in the user input using the NN model;
fetching based on a similarity between the intermediate entity feature and the stored context for each feature, a relevant context corresponding to the obtained intermediate entity feature from the context database; and
obtaining a context aware entity feature by concatenating the fetched relevant context with the sentence feature based on the intermediate entity feature having the similarity to the stored context that exceeds a threshold value.

10. The method as claimed in claim 9, further comprising:
generating a dynamic response for a user based on the context aware entity feature.

11. The method as claimed in claim 8, further comprising:
predicting an error in at least one electronic device among the plurality of electronic devices based on the extracted plurality of features corresponding to each of the plurality of electronic devices.

12. The method as claimed in claim 11, further comprising:
comparing the predicted error with the stored context in the context database; and
generating one or more actions based on a result of the comparison, wherein the one or more actions comprises at least one of notifying a user with a warning, calling a relevant application, initiating a relevant action, or providing a response to the user with relevant recommendation.

13. A method for generating a dynamic response in a virtual assistance system, the method comprising:
receiving a user input;
determining an intermediate entity feature and a sentence feature embedded in the user input by using a neural network (NN) model;
fetching a relevant context corresponding to the intermediate entity feature from a context database based on a similarity between the intermediate entity feature and a stored context for each feature;
determining a context aware entity feature by concatenating the fetched relevant context and the sentence entity feature based on the intermediate entity feature having the similarity to the stored context that exceeds a threshold value; and
generating a dynamic response for a user based on the context aware entity feature.

14. A virtual assistance (VA) system for generating a context, the VA comprising:
memory storing one or more instructions; and
one or more processors configured to execute the one or more instructions to:
receive raw data at each time step from a plurality of electronic devices connected with the VA device;
extract, using a first neural network (NN) model, a plurality of features corresponding to the plurality of electronic devices to generate a unified feature vector of the extracted plurality of features at the each time step;
determine, using a second NN model, an intermediate aligned feature at the each time step;
determine based on in the unified feature vector and the intermediate aligned feature, a context and a priority of the context at the each time step using the second NN model; and
store the context and the priority of the context for each feature in the unified feature vector in a context database.

15. A virtual assistant (VA) system for generating a dynamic response in a virtual assistance system, the VA system comprises:
memory storing one or more instructions; and
one or more processors configured to execute the one or more instructions to:
receive a user input;
determine an intermediate entity feature and a sentence feature embedded in the user input by using a neural network (NN) model;
fetch a relevant context corresponding to the intermediate entity feature from a context database based on a similarity between the intermediate entity feature and a stored context for each feature;
determine a context aware entity feature by concatenating the fetched relevant context and the sentence entity feature based on the intermediate entity feature having the similarity to the stored context that exceeds a threshold value; and
generate a dynamic response for a user based on the context aware entity feature.
